(19) United States
(12) Patent Application Publication
(10) Pub. No.: US 2025/0276467 A1
(43) Pub. Date: Sep. 4, 2025

(54) STRAND PELLETIZER

(71) Applicant: Maag Germany GmbH, Grossosstheim (DE)

(72) Inventors: Stefan Dahlheimer, Kleinostheim (DE); Matthias Namyslo, Aschaffenburg (DE)

(21) Appl. No.: 18/983,960

(22) Filed: Dec. 17, 2024

(30) Foreign Application Priority Data
Feb. 29, 2024 (DE) 10 2024 105 751.3

(51) Int. Cl. B29B 9/06; B02C 18/14; B02C 18/22

(52) U.S. Cl. CPC B29B 9/06; B02C 18/148; B02C 18/2283

(57) ABSTRACT

A feed device and a strand pelletizer including the feed device and a cutting mechanism having a rotationally drivable cutting rotor and a counter-knife cooperating therewith. The feed device has a pair of feed rollers rotatable in opposite directions in order to feed strands to the cutting mechanism. At least one of the feed rollers is mounted transversely to a longitudinal axis of the mounted feed roller in a movable manner by a movable roller suspension. An adjustment actuator linked to the movable roller suspension can be used to adjust a gap between, and/or the contact force between, the feed rollers. The adjustment actuator has an articulation point on the movable roller suspension and an articulation point on a cutting mechanism support on which the cutting rotor is mounted, so that the movable roller suspension and the cutting mechanism support are directly connected by the adjustment actuator.

### CROSS-REFERENCE TO RELATED APPLICATIONS

This application claims benefit under 35 USC § 119 of DE Application No. 10 2024 105 751.3 filed 29 Feb. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention generally relates to pelletizing, and more particularly to a feed device and a strand pelletizer for pelletizing strands such as strands of plastic material into pellets, with the feed device.

### 2. Description of Related Art

Conventional strand pelletizers are usually used for pelletizing strands of plastic material, which are produced by means of a caster and a corresponding nozzle plate and fed to the strand pelletizer via a drainage trough, cf. for example DE 31 45 613 A1, EP 0 079 609 A1 or U.S. Pat. No. 4,528,157 B1. By means of such strand pelletizers, which can also perform a dry cut, other materials such as food in the form of pasta strands or pharmaceutically active material strands can also be granulated into tablets. By feeding several strands side by side in parallel to the cutting mechanism, there can be achieved high throughput rates.

In this case, the cutting mechanism comprises a rotationally drivable cutting rotor, which can have rib-shaped or strip-shaped cutting projections on its circumferential surface, which interact with a stationary counter-knife. The counter-knife can substantially consist of a cutting strip that is positioned adjacent to the circumference of the cutting rotor so that the passing, strip-shaped projections of the cutting rotor can cut the strands of plastic material on the counter-knife.

In order to be able to feed the strands in controlled alignment and speed to the working area of the cutting mechanism, i.e., the area between the counter-knife and cutting rotor in controlled alignment and speed, a feed device is connected upstream of the cutting mechanism, which has feed rollers rotating in opposite directions, between which the strands are conveyed in order to be fed onto the cutting mechanism.

Such cutting mechanisms having a pair of feed rollers are known, for example, from the DE 101 06 677 C1, DE 34 26 316 A1, DE 31 45 613 A1 and DE 26 00 078 A1.

These feed rollers are usually designed in such a way that they can form a feed gap with variable gap dimensions in order to be able to adapt to different material strands or to irregularities in the material strands. For example, the feed gap can vary from 0 to 5 mm and can also increase significantly for a short time, for example up to 20 mm. In order to form the gap dimension between the feed rollers in such a variable manner, at least one of the feed rollers can be suspended transversely to its longitudinal axis of the roller by means of a movable roller suspension in a displaceable or movable manner, wherein to the movable suspension there is usually assigned an adjustment actuator, in order to be able to adjust the gap dimension between the feed rollers and/or the contact force between the feed rollers, wherein such an adjustment actuator may, for example, be a pneumatic cylinder in order to elastically pretension the movably suspended feed roller in a movable manner or to adjust the gap dimension in the desired manner. However, elastic pretensioning can also be achieved by means of a hydraulic cylinder having a pressure accumulator connected thereto, or by means of a mechanical spring device, for example in the form of a suspension strut.

The movable suspension of the feed roller can advantageously also be used to move the feed roller further away for maintenance purposes or for repairs in order to gain access to the cutting mechanism, which is usually blocked by the feed rollers in front of it. As the feed rollers have to guide the often less dimensionally stable strands precisely into the cutting mechanism gap between the cutting rotor and counter-knife, the feed rollers are often located directly in front of the cutting mechanism or in the immediate vicinity of it and cover the working area of the cutting mechanism including the counter-knife and cutting mechanism rotor.

In order to move at least one of the feed rollers away for maintenance or repair, it is practical if the feed roller or both feed rollers is/are mounted on a protective hood which, in the operating position, covers the feed rollers and possibly also part of the cutting mechanism and can be swung open into a maintenance position in which the cover hood exposes the feed device and the cutting mechanism. If the feed roller is mounted on the cover hood, it is automatically taken along when the lid or cover hood is opened and swung away from the cutting mechanism.

In order to achieve the desired variability of the gap dimension described above in the closed operating position, the adjustment actuator can act between the cover hood and the feed roller, with the movable roller suspension allowing corresponding movements between the feed roller and the cover hood.

However, these previous cover hood solutions are disadvantageous in various respects. On the one hand, the cover hood or the cutting chamber flap must be sufficiently stable to be able to absorb the contact forces from the adjustment actuator, in particular if the adjustment actuator is not supported on one of the side flanks, but on a ceiling surface of the cover hood. At the same time, the cover hood must also be locked to the lower housing or machine frame of the strand pelletizer in the closed operating position with sufficient stability or held to it in order to be able to introduce the operating forces occurring at the feed rollers and ensure the force flow. However, such sufficiently stable configured cover hoods are difficult to handle or additional opening aids such as relief springs are necessary to allow comfortable operation.

Above all, however, such previous cover hoods are relatively bulky and require sufficient installation space not only to reliably support the adjustment actuator, but also to accommodate any handling aids such as relief springs, so that the cutting head of the strand pelletizer is usually relatively high. Due to the relatively large size of the cover hood, it also forms a relatively large resonance chamber, which is detrimental to the desired noise insulation.

Proceeding therefrom, it is the object underlying the present invention to create an improved strand pelletizer of this named type which avoids disadvantages of the prior art and further develops the latter in an advantageous manner. In particular, there should be created a compact feed device with feed rollers rotating in opposite directions, which enables a variable gap dimension between the feed rollers during operation and allows easy access to the cutting mechanism for maintenance purposes without having to buy a heavy, bulky cover hood.

### BRIEF SUMMARY OF THE INVENTION

In an exemplary embodiment, the present invention is a feed device comprising a pair of feed rollers rotatable in opposite directions, a roller suspension from which at least one feed roller of the pair of feed rollers is movably mounted transversely to a longitudinal axis of the at least one movably mounted feed roller, and an adjustment actuator configured for linkage to the roller suspension at a first articulation point and a cutting mechanism support of a cutting mechanism of a pelletizer at a second articulation point, wherein the roller suspension and the adjustment actuator provide for adjustment of a gap dimension between the feed rollers of the pair of feed rollers and/or a contact force between the feed rollers of the pair of feed rollers.

The feed device can further comprise a releasable clutch configured to disengage the adjustment actuator from the roller suspension. The releasable clutch can be associated with the first articulation point in order to allow for the separation of the first articulation point and enable movement of the at least one movably mounted feed roller into a maintenance position.

In an exemplary embodiment, the present invention is a strand pelletizer for pelletizing strands into pellets comprising a cutting mechanism comprising a rotationally drivable cutting rotor, a counter-knife, and a cutting mechanism support on which the rotationally drivable cutting rotor is mounted, wherein strands entering the cutting mechanism can be sheared off by the rotationally drivable cutting rotor at the counter-knife, and a feed device comprising a pair of feed rollers rotatable in opposite directions, a movable roller suspension from which at least one feed roller of the pair of feed rollers is movably mounted transversely to a longitudinal axis of the at least one movably mounted feed roller, and an adjustment actuator configured for linkage to the movable roller suspension at a first articulation point and the cutting mechanism support at a second articulation point, wherein the roller suspension and the adjustment actuator provide for adjustment of a gap dimension between the feed rollers of the pair of feed rollers and/or a contact force between the feed rollers of the pair of feed rollers.

In an exemplary embodiment of the present invention, a strand pelletizer comprises a cutting mechanism having a rotationally drivable cutting rotor and a counter-knife cooperating therewith, and a feed device having a pair of feed rolls rotatable in opposite directions in order to feed the strands to the cutting mechanism, wherein at least one of the feed rolls is mounted transversely to its longitudinal axis of the roller in a movable manner by means of a movable roller suspension and a gap dimension between the feed rolls can be varied, wherein an adjustment actuator linked to the movable roller suspension is provided for adjusting the gap dimension and/or the contact force between the feed rolls, characterized in that the adjustment actuator has, on the one hand, an articulation point on the movable roller suspension and, on the other hand, an articulation point on a cutting mechanism support on which the cutting rotor is mounted, so that the movable roller suspension and the cutting mechanism support are directly connected by the adjustment actuator.

It is therefore proposed that the adjustment actuator for setting the contact forces or the gap dimension between the feed rollers not be supported on the cover hood, but instead be linked to the cutting mechanism support, which also supports the cutting rotor, so that the cover hood does need any more to absorb the adjustment forces of the adjustment actuator or the reaction forces of the feed rollers. According to the invention, it is proposed that the adjustment actuator has on the one hand an articulation point on the movable roller suspension and on the other hand an articulation point on a cutting mechanism support on which the cutting rotor is mounted, so that the movable roller suspension is connected directly to the cutting mechanism support by the adjustment actuator. Due to the direct linkage of the adjustment actuator to the cutting mechanism support, a direct force flow into the stable cutting mechanism support can be achieved without the operating forces or pretensioning forces of the feed rollers having to be diverted via a cover hood, so that a lightweight and also significantly smaller cover hood design is possible.

In order to enable the at least one feed roller to be moved away easily and sufficiently far for maintenance purposes or, for example, for repairs to the cutting mechanism, a releasable clutch for disengaging the adjustment actuator can be provided in an advantageous further development of the invention, wherein the clutch preferably disengages the adjustment actuator from the movable roller suspension so that the adjustment actuator does not have to be moved when the movable roller suspension is moved in order to move the feed roller away into the maintenance position. If necessary, the clutch can also disengage the adjustment actuator from the cutting mechanism support.

The releasable clutch can be configured as a manually releasable quick-acting coupling means that allows the adjustment actuator to be disengaged without tools. For example, such a quick-acting coupling means can have a detachable plug-in pin with a manually releasable locking mechanism which, when locked, attaches the adjustment actuator to the roller suspension or another linkage element in an articulated manner.

If necessary, non-manual actuation of the clutch can also be considered in order to prevent unintentional or unauthorized release of the clutch.

In a further development of the invention, the roller suspension can have a rocker for pivotably mounting the adjustable feed roller, wherein the rocker can be pivotably mounted about a swivel axis parallel to the longitudinal axis of the roller in order to be able to move the feed roller mounted on the rocker away from the other feed roller and/or from the cutting mechanism or back into the operating position by pivoting the rocker and, in the operating position, to be able to carry out the compensating movements for varying the gap dimension.

The swivel axis of the rocker can preferably be arranged on a side of the cutting mechanism that faces away from the inlet of the strands or from the feed rollers, so that, for example, the cutting rotor of the cutting mechanism lies between the rocker axis and the feed roller mounted on it, possibly with a transverse displacement thereto. This gives the rocker a relatively high lever arm so that, on the one hand, adjustment movements during operation relative to the other feed roller follow a path of movement that does not have too much curvature and, on the other hand, a path of movement that favorably overlaps the cutting mechanism can be achieved when moving up into the maintenance position.

Advantageously, the swing axis can be positioned in such a way that a movement of the feed roller mounted on it from the operating position contains both a component that leads away from the other feed roller and a component that leads away from the cutting rotor.

The cutting mechanism support can form a housing for the cutting head or the strand pelletizer, or it can also form a machine support frame that is different from it and can be enclosed by the housing.

Irrespective of this, the cutting mechanism support can have two support legs which extend approximately upright and can be arranged at opposite end portions of the cutting mechanism rotor in order to be able to rotatably mount the cutting rotor at opposite end portions on the support legs of the cutting mechanism support, for example by means of roller bearings or plain bearings.

The counter-knife, with which the cutting rotor interacts, can also be mounted on the two support legs, so that the support legs of the cutting mechanism support can accommodate the cutting mechanism between them, for example by guiding it past the cutting mechanism on the right and left.

If the cutting mechanism support has such support legs that accommodate the cutting mechanism between them, the adjustment actuator can be arranged on an outer side of the support legs and extend with its effective axis at least approximately parallel to the outer side.

In particular, the adjustment actuator can be arranged adjacent to the outer side of a support leg and can be linked to this support leg in order to introduce the actuating forces directly into the support leg.

Preferably, two adjustment actuators can be provided, which can be provided on the right and left on the outer sides of the support legs, in order to be able to pretension or move the movable feed roller in the desired manner on both sides and without tilting.

Advantageously, a pressure cylinder in the form of a tandem cylinder can be provided as an adjustment actuator in order to be able to apply sufficient actuating forces in a compact design. Advantageously, one such tandem cylinder can be provided on each side.

In particular, the at least one adjustment actuator can be linked to an end portion of the rocker, preferably by the detachable coupling means, the end portion of which is opposite the rocker axis. This allows the movable feed roller to be held stable in the desired working or operating position and the lever on the rocker to be utilized.

In particular, the articulation point of the adjustment actuator on the roller suspension can be positioned in the immediate vicinity of the movable feed roller in order to achieve the most direct possible force flow into the adjustment actuator in the rocker.

If the two feed rollers define a feed gap for the strands that is at least approximately horizontal, the adjustment actuator can extend upright or have an approximately upright effective line. Irrespective of this, an effective line of force of the adjustment actuator can be arranged approximately perpendicularly or transversely to a virtual connecting line that connects the rocker axis with the articulation point of the adjustment actuator on the rocker.

The feed device and/or the cutting mechanism can advantageously be enclosed by a cover hood, which can span an upper side of the feed device and/or the cutting mechanism. The cover hood can be pivotably mounted on the machine frame and/or a lower half of the housing, preferably about a horizontal hood pivot axis, which can extend parallel to the longitudinal axis of the roller of the movable feed roller. For example, the hood pivot axis can coincide with the pivot axis of the rocker of the roller suspension or be positioned in close proximity to it and extend at least approximately parallel to it.

The cover hood can form a sound-absorbing hood and enclose the feed device and/or the cutting mechanism on five sides. Preferably, the cover hood can be connected to a lower housing part on at least three sides without a gap, although a gap to the lower housing part can also remain depending on the design.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a perspective side/front view of the cutting head of a strand pelletizer according to an advantageous embodiment of the invention, wherein the two feed rollers of the feed device are shown in their operating position, in which the adjustment actuators are coupled to the roller suspension.

FIG. 2 is a sectional, perspective view of the adjustment actuator for adjusting the gap dimension and/or the contact forces between the feed rollers, wherein the adjustment actuator is shown in its position on the outer side of the cutting mechanism support and is uncoupled from the roller suspension in order to enable the feed roller to be moved into a maintenance position.

FIG. 3 is a sectional view of the cutting head of the strand pelletizer from the foregoing figures, which illustrates the position of the feed rollers relative to the cutting mechanism in the operating position and the low overall height of the cutting head made possible by the roller suspension.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The strand pelletizer 1 comprises a cutting mechanism 2 which has a driveable cutting rotor 3 to which a counter-knife 4 is assigned, so that strands entering the cutting mechanism 2, such as thermoplastic strands of plastic material, can be sheared off by the cutting rotor 2 at the counter-knife 4.

In a known manner, the cutting rotor 3 can have peripheral cutting projections 5, which can be configured in the form of strips and extend substantially over the entire length of the cutting rotor 3. The cutting projections 5 can be arranged substantially parallel to the longitudinal axis of the roller of the cutting rotor 3, but can also extend at an angle or extend slightly helically along the cylindrical enveloping surface of the cutting rotor 3.

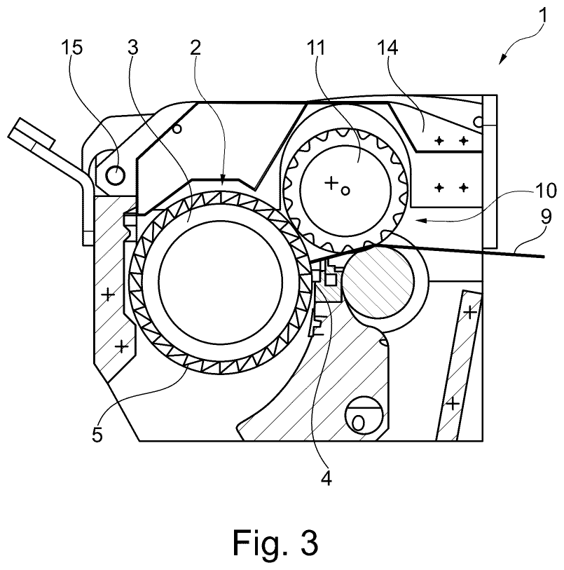

The counter-knife 4 is arranged on the enveloping surface of the cutting rotor 3 and can be configured in the shape of a strip or form a web-shaped blade, against which the cutting knife 2 passes with its cutting projections 5, cf. FIG. 3.

In this respect, the cutting mechanism 2 is mounted on a cutting mechanism support 6, which can have two upright support legs 7 and 8, between which the cutting mechanism 2 is arranged. On the support legs 7, 8 there can be mounted the cutting rotor 3 rotatably about its longitudinal axis of the roll, for example by means of roller or plain bearings, by means of which the cutting rotor 3 is fixed or mounted on the support legs 7, 8. The counter-knife 4 can be fixed stationary, for example also mounted on the support legs 7, 8.

In order to feed the strands 9 to the cutting mechanism 2 at a controlled speed and in a controlled direction, a feed device 10 is connected upstream of the cutting mechanism 2, which comprises two feed rollers 11, 12 rotating in opposite directions, which are advantageously driven in rotation, for example by an electric motor.

Also, the cutting rotor 3 of the cutting mechanism 2 can be rotationally driven by an electric motor, wherein the cutting mechanism 2 and the feed device 10 can have separate rotary drives, but alternatively can also be coupled to one another, so that the cutting rotor 3 and the feed rollers 11, 12 are driven by a rotary drive if necessary.

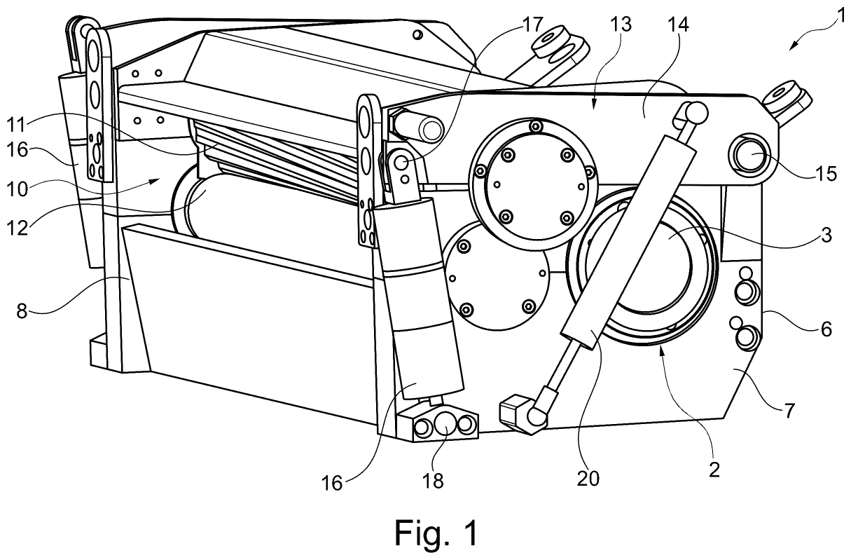

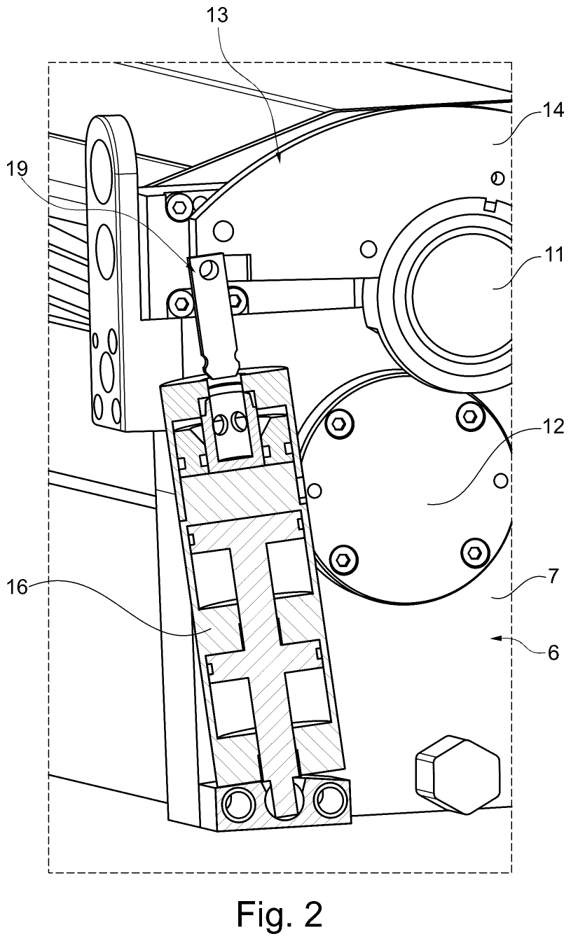

From among the feed rollers 11, 12, one feed roller 12 may have a smooth circumferential contour and the other feed roller 11 may have a relief-like circumferential contour with depressions and elevations. As shown in FIGS. 1 and 2, for example, the upper feed roller 12 can have strip-shaped circumferential projections that extend parallel to the longitudinal axis of the roll, but can also be set at a slight angle to it or can extend helically over the length of the feed roller 11, cf. FIG. 1 and FIG. 2.

In order to be able to vary the gap dimension between the two feed rollers 11, 12 during pelletizing operation, for example in a range of 0 to 5 mm or even significantly more in the short term, for example up to 20 mm, one of the two feed rollers, preferably the upper feed roller 11, can be movably mounted transversely to its longitudinal axis of the roll. Through such a transverse movement there can be compensated irregularities in the strands of plastic material, and in particular strands of different thicknesses can be processed.

The transverse mobility of the movable feed roller 11 is in this respect oriented such that the feed roller 11 can move away from and towards the other feed roller 12, preferably at least approximately perpendicular to the envelope contour of the other feed roller 12.

In order to enable the transverse movement of the feed roller 11, there is provided a movable roller suspension 13, which can comprise a pivotably mounted rocker 14, on which the transversely movable feed roller 11 is rotatably mounted. The rocker 14 can be pivotably mounted about a rocker pivot axis 15, which can extend at least approximately parallel to the longitudinal axis of the roller of the feed roller 11 and/or parallel to the longitudinal axis of the roller of the cutting rotor 3.

As shown, the rocker pivot axis 15 may be arranged on a side of the cutting mechanism 2 opposite or facing away from the infeed side or the side on which the feed device 10 is arranged. As FIGS. 1 and 3 illustrate, the rocker pivot axis 15 can be arranged in such a way that the cutting rotor 3 is arranged between the rocker pivot axis 15 and the movable feed roller 11, wherein the cutting rotor can have a transverse displacement relative to a virtual connecting line between the rocker pivot axis 15 and the longitudinal axis of the roller of the feed roller 11, cf. FIG. 3.

In particular, the rocker 14 can be arranged on an end portion of the cutting mechanism support 6, which is opposite the inlet end of the cutting mechanism support 6 or the inlet of the cutting head, cf. FIG. 1 and FIG. 3.

The rocker 14 may have two rocker legs, between which the feed roller 11 is received or arranged, wherein the rocker legs may be rigidly connected to each other by the rocker pivot axis 15. If necessary, however, the rocker arms could also be configured separately and mounted separately on the rocker pivot axis 15.

In order to be able to adjust the gap dimension between the two feed rollers 11, 12 and/or to variably adjust the contact force between the two feed rollers 11, 12, to the roller suspension 13 there is assigned an adjustment actuator 16, which can be configured, for example, in the form of a pressure medium actuator, in particular a pneumatic cylinder. In order to enable torsion-free or tilt-free actuation, two adjustment actuators 16 can be provided, which can be arranged on opposite end portions or sides of the feed device 10.

Such a pressure medium actuator, in particular a pneumatic cylinder, can advantageously be configured in the form of a tandem cylinder in order to be able to provide sufficiently high actuating forces in a compact design. Such a tandem cylinder can provide correspondingly higher forces thanks to an additional pressure chamber, without having to be oversized.

In particular, the two adjustment actuators 16 can engage on the two support legs of the rocker 14 and extend to the right and left on the outer side of the support legs 7, 8 of the cutting mechanism support 6.

The adjustment actuators 16 are each linked on the one hand to the rocker 14 and on the other hand to the cutting mechanism support 6, in particular to one of the support legs 7, 8. Due to the direct articulation points 17, 18 on the roller suspension 13, in particular the rocker 14 on the one hand and on the cutting mechanism support 6 on the other, the roller suspension 13 and the cutting mechanism support 6 are directly connected to each other by the adjustment actuators 16. There will be thus achieved a direct force flow, which introduces the operating and/or reaction forces of the feed device 10 acting on the rocker 14 directly into the cutting mechanism support 6 via the adjustment actuators 16, without the force flow having to take a detour via a cover hood or other components.

In order to be able to remove the feed roller 11 for maintenance purposes and to release the cutting mechanism 2, which is normally blocked by the feed device 10, the adjustment actuators 16 can advantageously be uncoupled from the roller suspension 13. A releasable clutch 19 can be assigned to the articulation points 17 of the adjustment actuators 16 on the rocker 14.

Irrespective of this, the coupling 19 can advantageously be configured as a quick-acting coupling means, which can preferably be actuated manually or without tools in order to allow easy disengagement.

In order to be able to easily swivel the rocker 14 with the quite heavy feed roller 11 mounted on it upwards into a maintenance position, a further adjustment actuator 20 can be assigned to the rocker 14, which is activated for the movement into the maintenance position and can be inactive in the operating position, wherein this additional actuator 20 can also be linked on the one hand to the cutting mechanism support 6, in particular its support leg 7, and on the other hand engages on the rocker 14, cf. FIG. 1. The actuator 20 can be a relief spring, for example, in order to relieve the weight of the pivotably mounted unit consisting of rocker 14 and feed roller 11. However, to enable motorized movement into the maintenance position, the actuator 20 can also be a hydraulic or pneumatic cylinder or, for example, comprise a spindle motor.

As shown in particular in FIG. 3, the cutting mechanism 2 and the feed device 10 can be covered by a cover hood 21 during operation, which can span the top of the cutting mechanism 2 and the feed device 10. Due to the described linking of the adjustment actuators 16 not to the cover hood 21, but to the support legs 7, 8 of the cutting mechanism support 6, the cover hood 21 can be configured to be lightweight and also small, in particular spanning the cutting mechanism and/or feed rollers at only a small distance.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A feed device comprising:
a pair of feed rollers rotatable in opposite directions;
a roller suspension from which at least one feed roller of the pair of feed rollers is movably mounted transversely to a longitudinal axis of the at least one movably mounted feed roller; and
an adjustment actuator configured for linkage to:
the roller suspension at a first articulation point; and
a cutting mechanism support of a cutting mechanism of a pelletizer at a second articulation point;
wherein the roller suspension and the adjustment actuator provide for adjustment of a gap dimension between the feed rollers of the pair of feed rollers and/or a contact force between the feed rollers of the pair of feed rollers.

2. The feed device of claim 1 further comprising:
a releasable clutch configured to disengage the adjustment actuator from the roller suspension.

3. The feed device of claim 2, wherein the releasable clutch is associated with the first articulation point in order to:
allow for the separation of the first articulation point; and
enable movement of the at least one movably mounted feed roller into a maintenance position.

4. A strand pelletizer comprising:
the feed device of claim 1; and
a cutting mechanism comprising:
a cutting rotor; and
a cutting mechanism support on which the cutting rotor is mounted;
wherein:
the adjustment actuator of the feed device directly connects the roller suspension and the cutting mechanism; and
the adjustment actuator is linked to the roller suspension at the first articulation point and linked to the cutting mechanism support at the second articulation point.

5. The pelletizer of claim 4, wherein:
the feed device further comprises:
a releasable clutch configured to disengage the adjustment actuator from the roller suspension;
the releasable clutch is associated with the first articulation point in order to:
allow for the separation of the first articulation point; and
enable movement of the at least one movably mounted feed roller into a maintenance position.

6. The strand pelletizer of claim 5, wherein at least one of:
the releasable clutch is further configured as a manual quick-acting coupling means to be actuated without tools;
the adjustment actuator comprises a pressure cylinder; or
the cutting mechanism support comprises two upright support legs.

7. The strand pelletizer of claim 5, wherein:
the cutting mechanism support comprises two upright support legs;
the cutting mechanism is arranged between the two upright support legs;
the cutting rotor is rotatably mounted on the two upright support legs; and
the second articulation point is located on one of the two upright support legs.

8. A strand pelletizer for pelletizing strands such as strands of plastic material into pellets, comprising a cutting mechanism having a rotationally drivable cutting rotor and a counter-knife cooperating therewith, and a feed device having a pair of feed rollers rotatable in opposite directions in order to feed the strands to the cutting mechanism;
wherein at least one of the feed rollers is mounted transversely to its longitudinal axis of the feed roller in a movable manner by means of a movable roller suspension and a gap dimension between the feed rollers can be varied;
wherein an adjustment actuator linked to the movable roller suspension is provided for adjusting the gap dimension and/or a contact force between the feed rollers; and
wherein the adjustment actuator has, on the one hand, an articulation point on the movable roller suspension and, on the other hand, an articulation point on a cutting mechanism support on which the rotationally drivable cutting rotor is mounted, so that the movable roller suspension and the cutting mechanism support are directly connected by the adjustment actuator.

9. The strand pelletizer of claim 8, wherein a releasable clutch is provided for disengaging the adjustment actuator in order to move the movable feed roller into a maintenance position.

10. The strand pelletizer of claim 9, wherein the releasable clutch is configured to disengage the adjustment actuator from the movable roller suspension;
wherein the releasable clutch is associated with the articulation point of the adjustment actuator on the movable roller suspension in order to separate the articulation point.

11. A strand pelletizer for pelletizing strands into pellets comprising:
a cutting mechanism comprising:
a rotationally drivable cutting rotor;
a counter-knife; and
a cutting mechanism support on which the rotationally drivable cutting rotor is mounted;
wherein strands entering the cutting mechanism can be sheared off by the rotationally drivable cutting rotor at the counter-knife; and
a feed device comprising:
a pair of feed rollers rotatable in opposite directions;
a movable roller suspension from which at least one feed roller of the pair of feed rollers is movably mounted transversely to a longitudinal axis of the at least one movably mounted feed roller; and
an adjustment actuator configured for linkage to:
the movable roller suspension at a first articulation point; and
the cutting mechanism support at a second articulation point;
wherein the movable roller suspension and the adjustment actuator provide for adjustment of a gap dimension between the feed rollers of the pair of feed rollers and/or a contact force between the feed rollers of the pair of feed rollers.

12. The strand pelletizer of claim 11 further comprising:
a releasable clutch configured to disengage the adjustment actuator from the movable roller suspension;
wherein the releasable clutch is associated with the first articulation point in order to:
allow for the separation of the first articulation point; and
enable movement of the at least one movably mounted feed roller into a maintenance position.

13. The strand pelletizer of claim 11 further comprising:
a releasable clutch for disengaging the adjustment actuator in order to move the at least one movably mounted feed roller into a maintenance position;
wherein the releasable clutch is configured as a manual quick-acting coupling means to be actuated without tools.

14. The strand pelletizer of claim 11, wherein:
the adjustment actuator comprises a pressure cylinder; and
the pressure cylinder is pressurized from a pressure source the pressure level of which is adjustable.

15. The strand pelletizer of claim 11, wherein:
the adjustment actuator comprises a pressure cylinder; and
the pressure cylinder is one of a pneumatic cylinder or a tandem cylinder.

16. The strand pelletizer of claim 11, wherein:
the cutting mechanism support comprises two upright support legs;
the cutting mechanism is arranged between the two upright support legs;
the rotationally drivable cutting rotor is rotatably mounted on the two upright support legs; and
the second articulation point is located on a first upright support leg of the two upright support legs.

17. The strand pelletizer of claim 11, wherein:
the movable roller suspension comprises a rocker on which the at least one movably mounted feed roller is rotatably mounted; and
the rocker is pivotably mounted about a rocker pivot axis that extends at least approximately parallel to the longitudinal axis of the at least one movably mounted feed roller.

18. The strand pelletizer of claim 11, wherein:
the cutting mechanism and the feed device are covered on an upper side by a cover hood; and
the cover hood is pivotably mounted on the cutting mechanism support about a pivot axis parallel to the longitudinal axis of the at least one movably mounted feed roller.

19. The strand pelletizer of claim 11, wherein:
the movable roller suspension comprises a rocker on which the at least one movably mounted feed roller is rotatably mounted;
the rocker is pivotably mounted about a rocker pivot axis that extends at least approximately parallel to the longitudinal axis of the at least one movably mounted feed roller;
the cutting mechanism and the feed device are covered on an upper side by a cover hood; and
the cover hood is configured separately from the rocker and is pivotable independently of the rocker.

20. The strand pelletizer of claim 16, wherein the adjustment actuator extends on an outer side of the first upright support leg.

21. The strand pelletizer of claim 17, wherein the rocker pivot axis is arranged on a side of the cutting mechanism facing away from the feed device.

22. The strand pelletizer of claim 17, wherein the adjustment actuator is linked to an end portion of the rocker which is disposed opposite the rocker pivot axis.

23. The strand pelletizer of claim 18, wherein:
the cover hood is decoupled from support forces supporting the feed device; and
the cover hood is disposed outside a force flow that conducts operating and/or reaction forces of the feed device away into the cutting mechanism support.

24. The strand pelletizer of claim 18, wherein at least one of:
the cover hood has a hood ceiling that has a first clear distance from the feed device; or
the cover hood has a hood ceiling that has a second clear distance from the cutting mechanism.

25. The strand pelletizer of claim 20, wherein the adjustment actuator extends substantially parallel on the outer side of the first upright support leg.

26. The strand pelletizer of claim 21, wherein the rotationally drivable cutting rotor is arranged between the rocker pivot axis and the at least one movably mounted feed roller.

27. The strand pelletizer of claim 21, wherein the rotationally drivable cutting rotor has a transverse displacement relative to a virtual connecting line between the rocker pivot axis and the longitudinal axis of the at least one movably mounted feed roller.

28. The strand pelletizer of claim 24, wherein at least one of:
the first and second clear distances are both smaller than a diameter of the at least one movably mounted feed roller; or
the first and second clear distances are both smaller than a diameter of the rotationally drivable cutting rotor.
